(19) United States
(12) Patent Application Publication
(10) Pub. No.: US 2012/0081275 A1
(43) Pub. Date: Apr. 5, 2012

(54) Media Display Device

(75) Inventors: John Helmes, Cambridge (GB); Nicolas Villar, Cambridge (GB); Kenton O'Hara, Bristol (GB)

(73) Assignee: Microsoft Corporation, Redmond, WA (US)

(21) Appl. No.: 12/898,017

(22) Filed: Oct. 5, 2010

(51) Int. Cl. G09G 5/00

(52) U.S. Cl. 345/156

(57) ABSTRACT

A media display device is described. In an embodiment the media display device comprises a display screen and at least one loudspeaker held in a housing rotatably mounted on a lid. For example, in a one handed operation a user is able to rotate the housing to open the device and reveal the display screen which is held upwards using the lid as a stand. For example, the action of opening the device is detected by a sensor and triggers the device to randomly select an item of media content and to display that. For example, images, audio clips, contacts or other items that a user has not opened for some time are presented. The device may randomly select the media type in some embodiments. In an example the sensor is provided by a rotary encoder which also provides part of a hinge for mounting the housing and lid.

### BACKGROUND

People accumulate an enormous amount of digital content such as photographs, videos, music, tweets, blog posts, emails, and other such content. The digital content is accumulated on a variety of different media devices such as dedicated storage devices, personal computers, laptops, online repositories and other media devices. Over time, people typically forget about the accumulated digital content and so do not access it any more. If a user is able to remember particular content that he or she created some time ago then he or she may be able to find that content using a search engine or other search mechanism. However, if the user is unable to remember any characteristics of the stored content, it is unlikely that that content will be accessed again.

Media display devices such as digital photo frames are known which display digital photographs sequentially without the need for user input. However these devices are typically static and are limited in the amount of content they are able to store and/or display.

Other media display devices such as personal computers and personal digital assistants enable digital media such as emails, documents, SMS messages, audio files and the like to be displayed. Typically these devices provide a graphical user interface that a user is able to operate in order to control the display of the media items. However, it is often difficult for a user to cope with the large amounts of media content accumulated on such devices.

The embodiments described below are not limited to implementations which solve any or all of the disadvantages of known media display devices.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

A media display device is described. In an embodiment the media display device comprises a display screen and at least one loudspeaker held in a housing rotatably mounted on a lid. For example, in a one handed operation a user is able to rotate the housing to open the device and reveal the display screen which is held upwards using the lid as a stand. For example, the action of opening the device is detected by a sensor and triggers the device to randomly select an item of media content and to display that. For example, images, audio clips, contacts or other items that a user has not opened for some time are presented. The device may randomly select the media type in some embodiments. In an example the sensor is provided by a rotary encoder which also provides part of a hinge for mounting the housing and lid.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a perspective view of an example media display device in a closed state;

FIG. 2 is a perspective view of an example media display device in an open state;

FIG. 3 is a schematic diagram of an example media display device;

FIGS. 4-7 are a sequence of side views of the media display device of FIGS. 1 and 2 showing opening of the device;

FIG. 8 is a schematic diagram of an example media display device connected to a content scraper located on a personal computer;

FIG. 9 is a flow diagram of an example method of display screening content at a media display device;

FIG. 10 is a schematic diagram of an example content scraper located on a media display device;

FIG. 11 is a flow diagram of an example method of carrying out content scraping;

FIG. 12 is display rear view of the media display device of FIGS. 1 and 2 in a closed configuration;

FIG. 13 is a perspective view of the media display device of FIG. 12;

FIG. 14 is a display perspective view from below of a media display device;

FIG. 15 is a front view of the media display device of FIGS. 1 and 2 showing the display screen;

FIG. 16 is a perspective view of the lid of the media display device of FIGS. 1 and 2 showing the hinges and with other components removed for clarity;

FIG. 17 is another perspective view of the lid and hinges of FIG. 16;

FIG. 18 is a side view of the lid, hinge and display screen of the media display device of FIGS. 1 and 2 with other components removed for clarity;

FIG. 19 is a perspective view of the media display device of FIGS. 1 and 2 with the display screen and loudspeaker removed;

FIG. 20 is a perspective view of the media display device of FIG. 19 with the main processing board removed;

FIG. 21 is a plan view of the media display device of FIGS. 1 and 2 in closed configuration;

FIG. 22 is a schematic diagram of another example media display device;

FIG. 23 illustrates an exemplary computing-based device in which embodiments of a media display device may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an audio and visual display screen system, the system described is provided as an example and not a limitation. As those skilled in the art will appreciate, the present examples are suitable for application in a variety of different types of content display screen systems.

It is recognized here that existing media display devices do not provoke the curiosity or interest of a user into interacting with the device. Often it is too time consuming and/or complex to interact with existing media display devices. This is especially so where users are engaging in other activities or tasks; that is the user's primary task is not to view or listen to media content items.

In the embodiments described herein a media display device is described which is designed to have two states, open and closed, and to transition between those states in a simple manner. The act of opening or closing the device may cause it to display a media item in a serendipitous manner. The form of the device and the way in which it transitions between the open and closed states are designed to provoke the interest of a user. The curiosity of a user is provoked on seeing the device and when the user opens the device a media item is displayed. For example, the media item is selected at random from a store of media items on the device. The store of media items on the device may have been populated with media items scraped from other devices or pulled from the internet and which have not been viewed for a long time (or which have not been viewed before). The store of media items may have been intelligently scraped so that the device presents items randomly selected from the pre-selected scraped items for example, using a recommender system or other intelligent scraping technology. For example, the scraped items may comprise contacts not opened for a long time, potential new contacts recommended by a recommender system as being worthwhile getting in touch with, photographs not viewed for a long time or audio tracks not played in the recent past. The media type of the content item may itself be randomly selected by the device. For example, the content item display screened by the device may be an audio file, a photograph, a contact, a video file, an email or other type of content item.

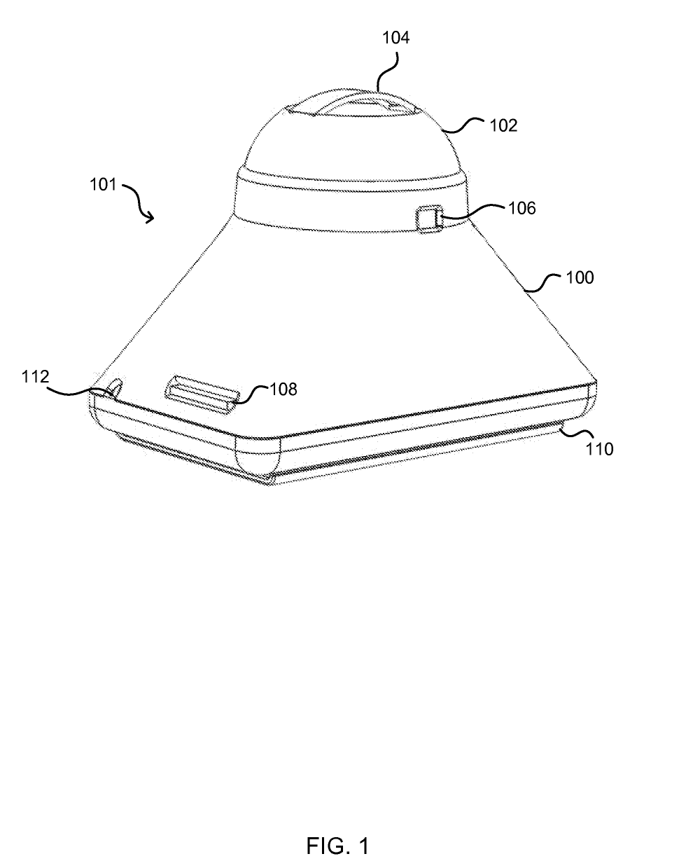

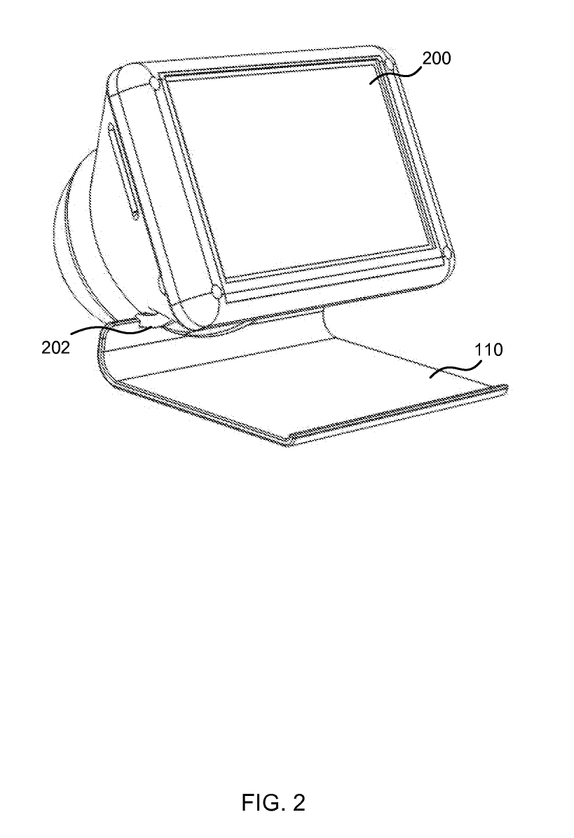

FIGS. 1 and 2 are perspective views of an example media display device 101 which is sized and shaped to rest on a surface and optionally to be opened with a one-handed interaction. FIG. 1 shows the device in a closed position and FIG. 2 shows the device in an open position. The media display device 101 comprises a housing 100 which supports or holds a loudspeaker 102 as well as a display screen and various other components which are described in more detail below. The housing may be formed from plastic or any other suitable material which is able to hold the loudspeaker and screen and which may be easily manufactured to the required size and shape. The loudspeaker may additionally comprise a protective bar 104 to prevent the loudspeaker from being damaged during use. An on/off button 106 may be incorporated into the housing 100 to turn the power on or off for the whole device or parts of it. However, this is not essential. The device may have an access slot 108 for a memory card reader although other memory may be provided for enabling media items to be stored at the device. A wireless communications interface, the memory card, or other input mechanism may be used to import and/or export media items to/from the device. In the closed position a display screen (not shown in FIG. 1) is obscured by a lid 110. The lid 110 can additionally form the base of the media display device so that the device can be placed on a table or other surface by standing it on the lid. In the closed configuration the media display device may present audio files or clips by outputting those to the loudspeaker.

In the example shown in FIG. 1 the device is arranged to rest on a surface such as a table, worktop, shelf or other surface. The housing 100 may be sized and shaped to act as a handle so that a user is able to open the device with one hand by placing his or her hand around the housing 100 with the loudspeaker 102 in the palm of his or her hand and his or her fingers and thumb gripping the housing 100. The user may then open the device with one hand as described in more detail below. However, this is not essential. Other sizes and shapes of housing may be used as described in more detail below.

The media display device 100 may have a power supply socket 112. In an example the power supply socket 112 is a DC socket. In another example the power supply socket 112 is a USB socket. It is also possible for the device to be fully or partly battery powered.

When the media display device is opened, as shown in FIG. 2 a display screen 200 becomes visible. In order to open the device in this example the lid 110 is rotated with respect to the housing 100. In this example, the lid 110 is rotatably mounted on the housing at least one hinge 202 such that the device is movable between an open configuration and a closed configuration. However, it is not essential to use a hinge. Any other way of rotatably mounting the lid on the housing may be used.

In an embodiment the loudspeaker 102 and the display screen 200 are located opposite each other such that when the device is closed the loudspeaker 102 may be used as the preferred means to communicate a media item and when the device is open the display screen 200 may be the preferred means of communicating a media item. In other embodiments the display screen and the loudspeaker may be used simultaneously.

In an example a media item is selected for display from a plurality of media items stored at the device. For example, the media display device randomly selects and presents one media item each time the device is opened. The media item can be stored at a memory card installed in memory card slot 108 or in another example can be stored in an internal memory. In another example the media display device is able to connect to a wireless network and items may be selected and displayed dynamically from media items stored at a personal computer, public database, web-based service or other storage mechanism. The wireless network may be any appropriate type of wireless network for example a personal area network (PAN), for example Bluetooth™, a local area network (LAN) or wide area network (WAN). In a further example the device may be connected to the personal computer or storage device using a USB cable or other wired connection. In other embodiments the media may be transferred by the user from two or more separate devices using a media card, memory stick or other storage device or by connecting to another device using the USB cable or other connection, or by using any combinations of these media transfer mechanisms.

The media items are selected from the plurality of media items using content scraping which is described in more detail below. In an embodiment the media display device displays an image on the display screen when open and can play an mp3 or other audio file through the loudspeaker when closed. However, in other embodiments the device may display images simultaneously with playing sound, for example in a video clip. A non-exhaustive list of appropriate types of media item are; audio files, images, video files, short message service (SMS) messages, emails, documents, updates from social networking sites, text-based social networking posts of limited length, contacts, blogs, posts, web pages, parts of any of these items or a combination of one or more of these items.

The display device may additionally have an on/off switch which the user can operate to activate the device. In an embodiment an on/off switch 106 may disable and enable the loudspeaker, for example in situations where the user does not wish the device to play sound. In another embodiment the on/off switch may disable and enable the whole device. In another embodiment the device may not have an on/off switch and may automatically turn on when the position is changed from open to closed or vice versa.

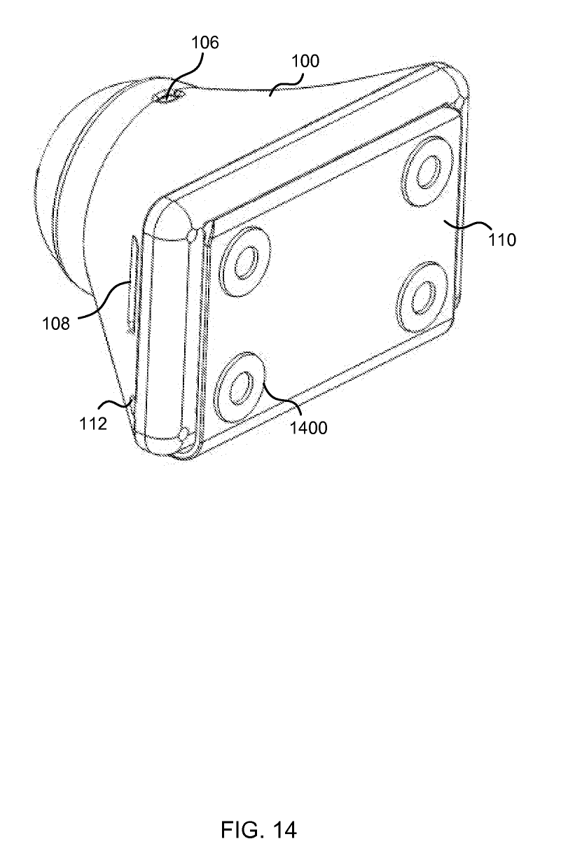

In an embodiment the lid 110 is a base for the device such that when the device is open it acts as a stand to support the housing and display screen so that the display can be tilted towards a user (see FIG. 2). In an embodiment the lid is weighted to act as a counterbalance to the device when open and prevent it from toppling over. Also, by weighting the lid one handed opening of the device is facilitated. The lid may also be provided with suction cups or other anti-slip devices (see FIG. 14) to help prevent the lid from slipping against a table or other surface during one-handed opening of the device. In an example the housing 100 and lid 110 are sized, shaped and weighted to enable the device to be opened using one hand.

The device is designed such that its size and shape and the form of the handle integral with the housing provokes a user to open the device. The action of opening the device triggers automatic selection and presentation of a single item (or multiple items) of media content. For example, the items of media content are ones which have not recently been opened or used. Presentation of the item(s) of media content then also provoke the user's interest further and may prompt the user to take further action. For example, by displaying a selected piece of media the user's curiosity will be provoked or their memory prompted. For example by displaying a photo of a person that the user has not contacted in some time it may prompt the user to get back in touch. In other examples the device may display messages or emails that the user has not yet responded to, prompting them to respond. The action of opening and closing the device is a minimal interaction on behalf of the user. This interaction encourages the user to open and close the device driven by curiosity in order to have a media item presented to them. The minimal interaction also makes the device suitable for users of all ages and those who may have mobility problems which would prohibit more complex interactions such as using a keyboard and mouse, a graphical user interface or navigating folders and files in a user interface.

In some examples the media display device is also used to enable users to make decisions about which content to store. For example, the display screen may be a touch screen which enables a user to give feedback about whether to keep content or delete it. This user input maybe sent from the device to another repository from which the content was scraped.

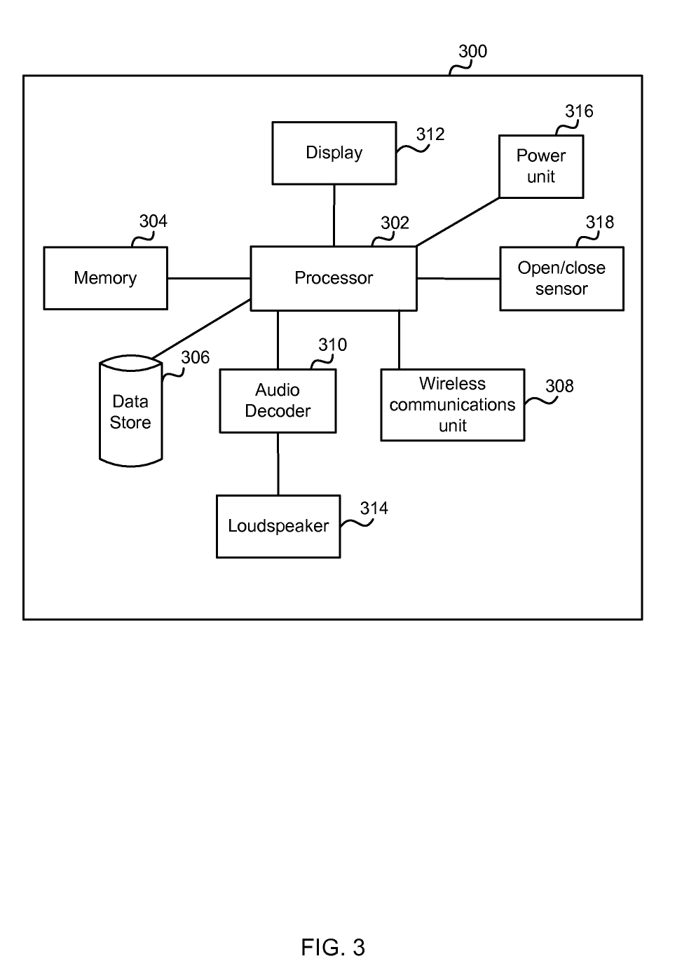

FIG. 3 is a schematic diagram of an example media display device. The media display device 300 comprises a processor 302 of any suitable type for use within a hand held device. A memory 304 is provided in communication with the processor 302 and optionally also a data store 306 for holding media items is provided in communication with the processor 302.

For example, the processor 302 is arranged to select media items from memory 304 and/or from the integral data store 306 and/or from an external storage device using a wireless communication unit 308. Depending on the type of media item selected and whether the processor determines, using an open/close sensor 318 that the device is open or closed, the media item is either displayed at a display 312 or converted using an audio decoder 310 to analog output and played via a loudspeaker 314.

The term loudspeaker 314 may refer to individual electro-acoustic transducers or to complete loudspeaker systems consisting of an enclosure including one or more electro-acoustic transducers. In other examples different types of loudspeaker systems may be used, for example flat-panel loudspeakers. The loudspeaker 314 is under the control of the processor 302 via an audio decoder 310.

The display 312 may be any appropriate display device. A non-exhaustive list of examples of appropriate display devices is: thin Film Transistor (TFT), Liquid Crystal Display screen (LCD), Light Emitting Diode (LED), Organic Light Emitting Diode (O-LED). In an embodiment the display screen 312 may additionally be a user input device, for example a touch-screen device.

The device may have an integrated power unit 316 such as a Li-ion battery and additionally or alternatively an external power supply, for example a mains power cable or USB cable.

The media display device preferably has a small number of components to facilitate ease of interaction and simplicity of production as well as reducing manufacturing costs.

The media display device 300 comprises at least one open/close sensor 318 which is arranged to detect a change in the configuration of the media display device. For example, the open/close sensor may be a light sensor, pressure sensor, rotary encoder, switch, or other sensor arranged to detect opening and/or closing of the media display device. The open/close sensor is connected to the processor 302 such that sensor data is provided to the processor.

In other embodiments the media display device also comprises a drive mechanism for automatically opening or closing the device. This drive mechanism is under the control of the processor 302.

More detail about the media display device of FIGS. 1 and 2 is now given.

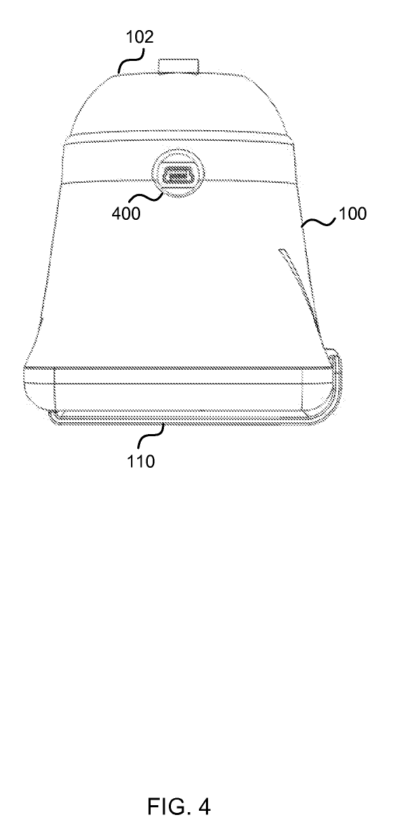

FIG. 4-FIG. 7 are a sequence of side views of the media display device of FIGS. 1 and 2 showing the device opening. In FIG. 4 the device 100 is closed. The loudspeaker 102 is vertical and the lid 110 acts as a base and obscures the display screen. Additionally visible in FIGS. 4-7 is a USB port 400 which may be used to connect the device to an external data store, to transfer scraped media items to the device, or as a power supply for the device.

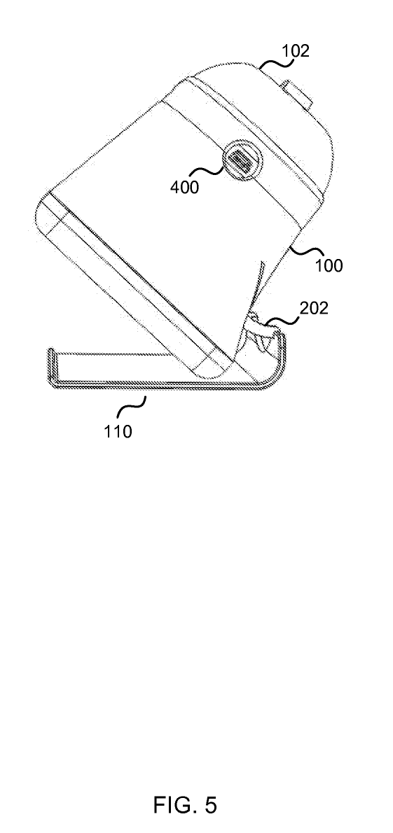

In FIG. 5 the device is shown partially open and the hinge 202 is visible. More detail about the hinge is given below.

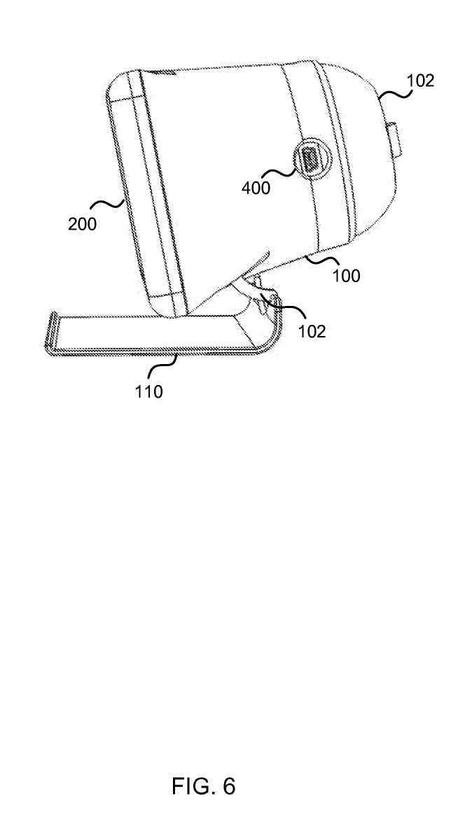

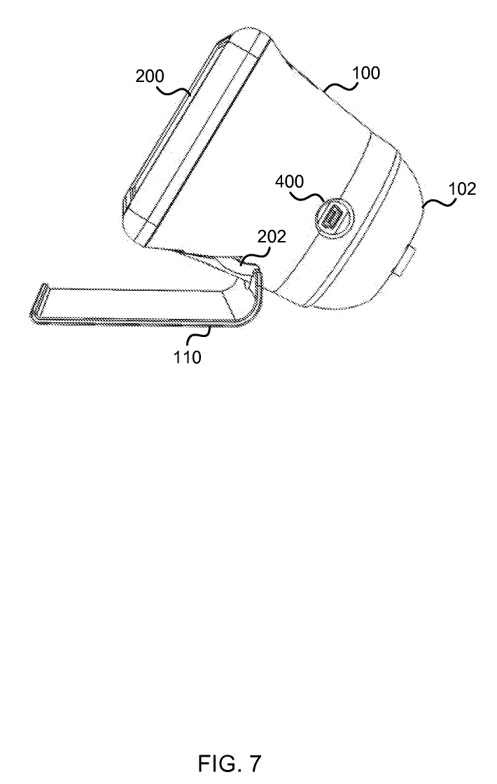

FIG. 6 shows the media display device 100 almost fully open, such that the display screen 200 is visible. FIG. 7 shows the display device fully open such that images can be displayed on the display screen 200 and can be watched by a user. In addition video sequences with sound may be presented using both the display screen 200 and loudspeaker 102.

In an example a user may wish to view a media item on the device. In a preferred example the device can be open by the user using one hand to rotate the housing 100 with respect to the lid 110 through the positions described with reference to FIGS. 4-7, however both hands may be used to open the device.

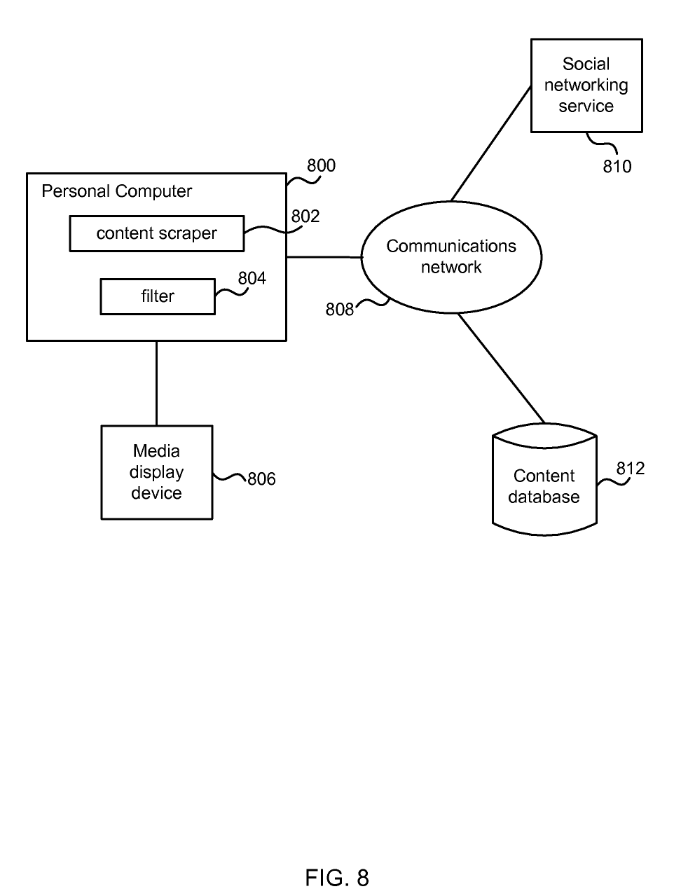

FIG. 8 is a schematic diagram of an example where a content scraper is located on a personal computer 800. The content scraper 802 and optionally a filter 804 are installed on a personal computer 800 which in an example is the user's personal computer. The content scraper 802 may scrape media items from a plurality of media items situated on the personal computer hard disk to be displayed on the media display device 806. The content scraper may alternatively or additionally scrape content from other locations over a communications network 808. Examples of locations that the content scraper may scrape media items from are social networking services 810 and external content databases 812.

In an example the content scraper is located on a user's computer and scrapes items according to specified metadata. For example the content scraper may scrape content according to whether or not the content has been accessed, opened or used recently. A non-exhaustive list of examples of appropriate metadata is; when the content was last edited, when the content was last opened, when the content was last used, when the content was created, tags, previous ratings by the user or others, whether the content has been shared. In another example the content scraper 802 may scrape content according to at least one criteria. In an embodiment the content scraper 802 accesses all content on the hard disk or other content sources and scrapes material randomly. In another embodiment the content scraper 802 accesses all content on the hard disk or other sources and scrapes according to specified criteria.

In an example the specified criteria is that the content is scraped according to metadata associated with the content. For example the content may be scraped for display according to the date of creation, date of last edit, data of last access, tags associated with the content, for example names or location or other appropriate content. In another example the content scraper may select media content based on past behavior, for example if the user has recently accessed similar content (or has not recently accessed similar content), types of music recently played or other behavior. In another example the content scraper may use face or object recognition in order to select content to be scraped. In a further example the content scraper 802 may use a recommender system in order to select content to be scraped, for example by selecting content that has been highly rated by friends or by a certain threshold of anonymous reviewers or is similar to other content that the user has highly rated.

In some embodiments the content scraper may be connected to or comprise a filter 804. The filter 804 may be used in order to determine whether content should be displayed to a user of the device, for example if content is age appropriate for a user. In another example the filter may utilize user feedback in order to determine which content to scrape for display. In an example if the display screen 200 is a touch screen a user may be able to press the screen in order to give feedback on content. For example if the user touches one corner it may mean “do not display this content again” and if they touch another corner it may mean “show me more like this”. This input may then be used by the filter in order to determine which content to display from the scraped content. In some examples where the display screen 200 is a touch screen it may be used to control video and/or audio playback by providing controls for functions such as play, stop, pause, fast forward, rewind and volume control.

Content may be scraped across a communications network from a social network service 810 or other online content database 812. This may comprise scraping content from any of text based services, photo and video sharing websites, blogs or other appropriate social networking content.

The scraped content can be transferred to the device for display. In an embodiment all of the content can be transferred to the integrated storage on the media display device. The content can be transferred offline, for example the content be download at a specified time when the user is unlikely to be using the content, e.g. overnight. The content may be transferred using the communications network 808 or other appropriate means, for example using a USB cable, memory stick, memory card or other storage device. In another example the content can be scrapped and transferred in an online on-the-fly manner directly from the personal computer to the media display device. In an example where the content is transferred on-the-fly the content may be scrapped according to specified criteria, user feedback or other appropriate means.

In an example where the content scraper is located on a user's personal computer the content scraper may be constantly running in the background using spare CPU capacity. The user interaction with the content scraper may be minimized and the need to have a significant amount of processor power or large amount of memory at the media display device 100 is reduced allowing the media display device to be simplified.

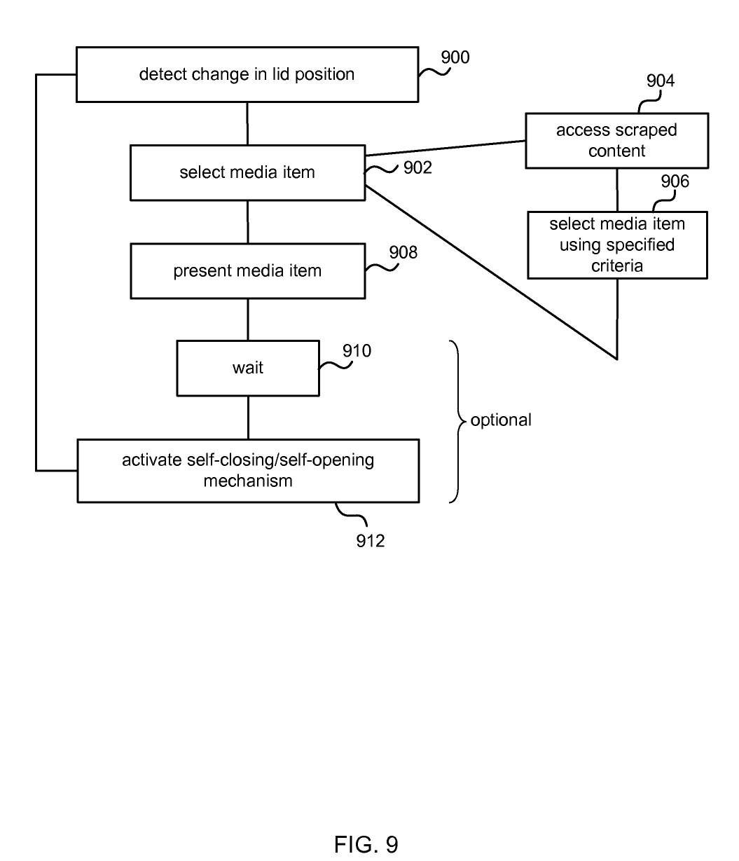

FIG. 9 is a flow diagram of an example method of displaying content at a media display device. A change in the position of the lid is detected 900 by the processor (as a result of receiving sensor data) which indicates that an item of content is to be selected. A media item is selected 902 for display. Selecting a media item for display involves the processor accessing 904 scraped content which may be stored at the device and selecting 906 a media item using specified criteria. The media item may be selected randomly or according to other specified criteria. The specified criteria may be one of the criteria described above used for scraping the content or any other appropriate criteria. The media item is presented 908 to the user and the device may wait 910 for a specified period of time before automatically activating a self-opening/self-closing mechanism 912. The waiting step and the self-closing or self-opening steps are optional.

A sensor mechanism is used to detect 900 a change in the position of the lid to trigger selection of a media item. In an embodiment the hinge 202, which is used to open and close the lid, may comprise a rotary encoder such that the device can use input from the rotary encoder to determine whether the lid is open or closed. In other embodiments the device may use other types of sensor to detect a change in the position of the lid relative to the housing.

In an example, when the device detects it is open it may select 902 an appropriate type of media item such as an image for display. In another example, if the device selects 902 a media item which is played through the loudspeakers it may display at the display screen a prompt to the user to close the device. In a further example the device may close or open automatically depending on the kind of media that is selected 902.

In an embodiment the selecting 902 may be done randomly. In other embodiments in may be carried out according to specified criteria. In an example where the content is scraped on a random basis the selecting 902 may be carried out according to one or more of the specified criteria described above.

In some embodiments the device may wait 910 for a specified time period before activating a self-opening/self-closing mechanism. In an example the device may wait 910 a specified period of time for user feedback to be input, for example the user input may comprise feedback such as “do not show this again”, “show similar items”. The user input may be received via a touchscreen display 200. The user feedback may also comprise input telling the device whether to display further items or not. If no input is received the device may automatically activate the self-opening/self-closing mechanism and turn-off in order to conserve power.

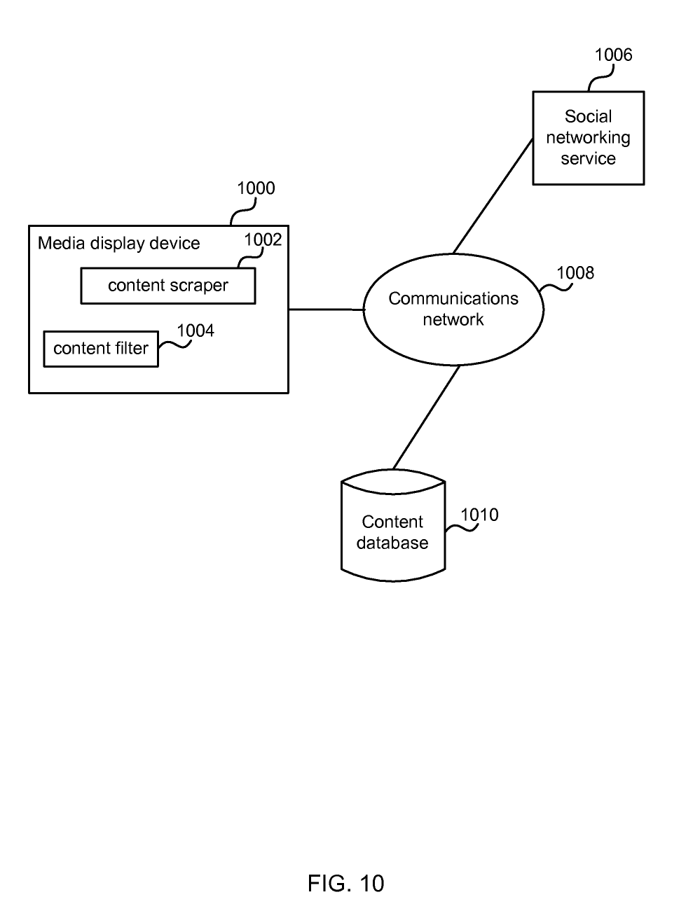

An alternative content scraping embodiment to that described with reference to FIG. 8 is described with reference to FIG. 10. FIG. 10 is a schematic diagram of an example where a content scraper is located on a media display device 1000. The content scraper 1002 and optionally a filter 1004 are installed on the media display device rather than on the user's personal computer as described in FIG. 8 above. The content scraper 1002 may scrape media items from a plurality of media items to be displayed on the media display device 1000. The content scraper may scrape content from locations over a communications network 1008. Examples of locations that the content scraper may scrape media items from are social networking services 1006 and external content databases 1010. The content scraper 1002 may additionally scrape items from the user's hard disk or other locations as described with reference to FIG. 8.

The content scraping in FIG. 10 can be carried out online such that images and other media items are scraped as necessary in response to user feedback or other specified criteria. This means that media items are not stored on the media display device but are instead scraped and displayed dynamically. The online dynamic scraping of content means that the device does not have to be connected to a user's personal computer in order for new content to be retrieved. Alternatively content scraping can be carried out offline as described above with reference to FIG. 8

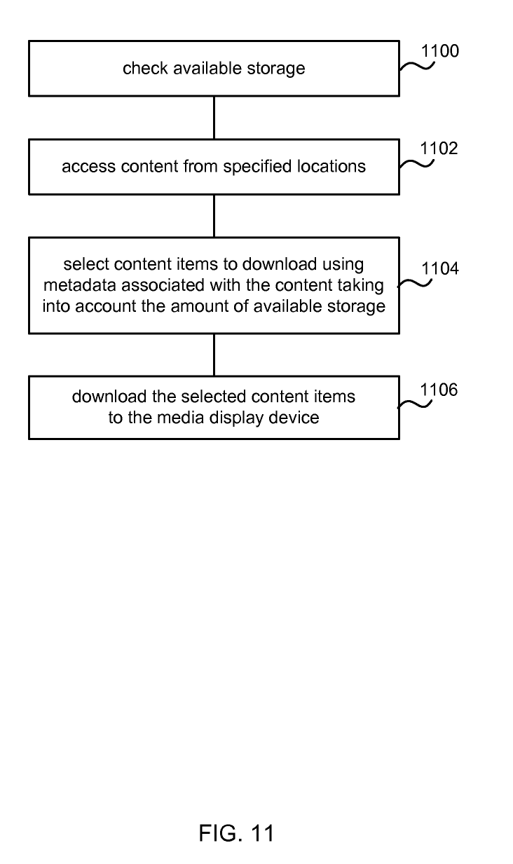

FIG. 11 is a flow diagram of an example method of carrying out content scraping. The content scraper carries out a check 1100 of the available storage space on the media display device. Content from specified locations is accessed 1102. For example, a user may have specified that content is to be scraped from particular directories or folders on his or her hark disk and or from particular web sites. Content items are selected 1104 to download using metadata associated with the content and taking account of the amount of digital storage available. Appropriate types of metadata are described above with reference to FIG. 8. The selected content items are then downloaded 1106 to the media display device.

In an embodiment the check 1100 determines that there is a certain amount of storage space available on the media display device. If there is sufficient storage the content scraper may select sufficient items to fill the available space or up to a certain threshold level, for example 75% full or 100 items. If there is insufficient storage space the content scraper may abort the selection of further examples. In another example the content scraper may delete items or request that the user selects items for deletion.

As described above the content items may be downloaded to the media display device wirelessly using a communications network, via USB cable or other appropriate connection or physically transferred by the user from a first location to a second location using a memory stick, memory card or other appropriate storage device. The content may be transferred offline e.g. overnight or online as required.

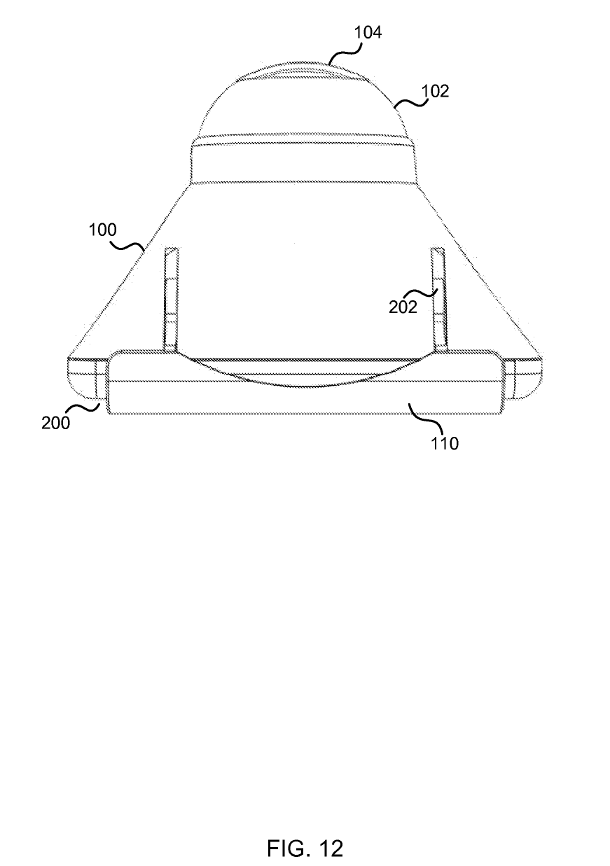

FIG. 12 is a rear elevation of an example media display device in a closed configuration. The media display device 100 is shown such that the display screen 200 is concealed by the lid 110 and the loudspeaker 102 is uppermost with the device resting on the lid on a surface such as a table. As before the loudspeaker may additionally incorporate a handle 104. The housing may additionally comprise slots through which the hinges 202 connecting the housing to the lid are visible. In an example the hinges may each comprise a rotary encoder.

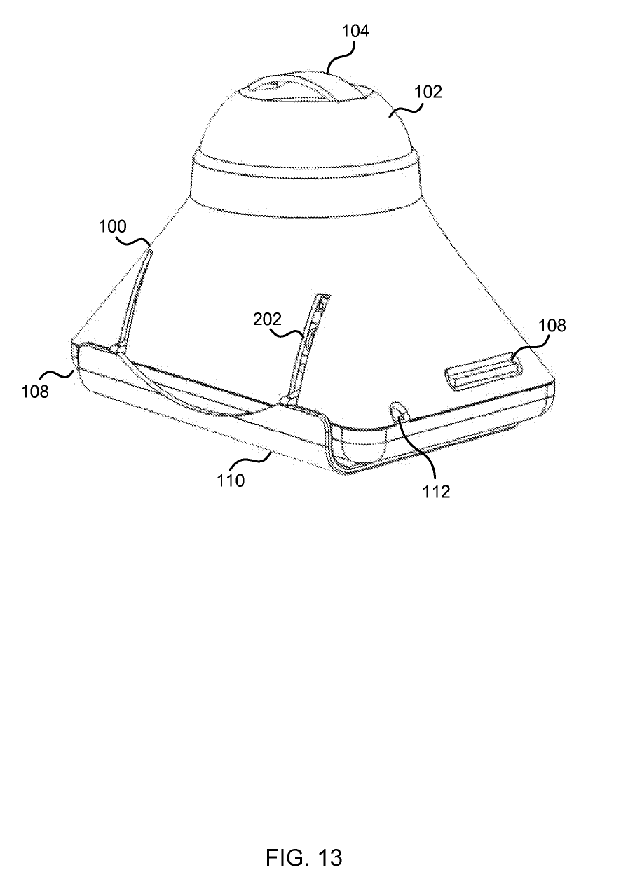

FIG. 13 is an example perspective view of the media display device of FIG. 12. Memory card slot 108 and power supply socket 112 are additionally visible.

FIG. 14 shows the base of an example media display device 100. The base comprises a lid 110. In an example the lid may have additional features in order to improve its adhesion to a surface on which the device is located. In the example shown in FIG. 14 a plurality of suction cups 1400 are used to secure the base of the device to a surface. In other examples a textured surface or a weighted base which acts as a counterbalance for the display screen may be used in order to hold the device on a surface. The provision of a mechanism to enable the device to be held to a surface facilitates one handed operation of the device without the device sliding or tipping over.

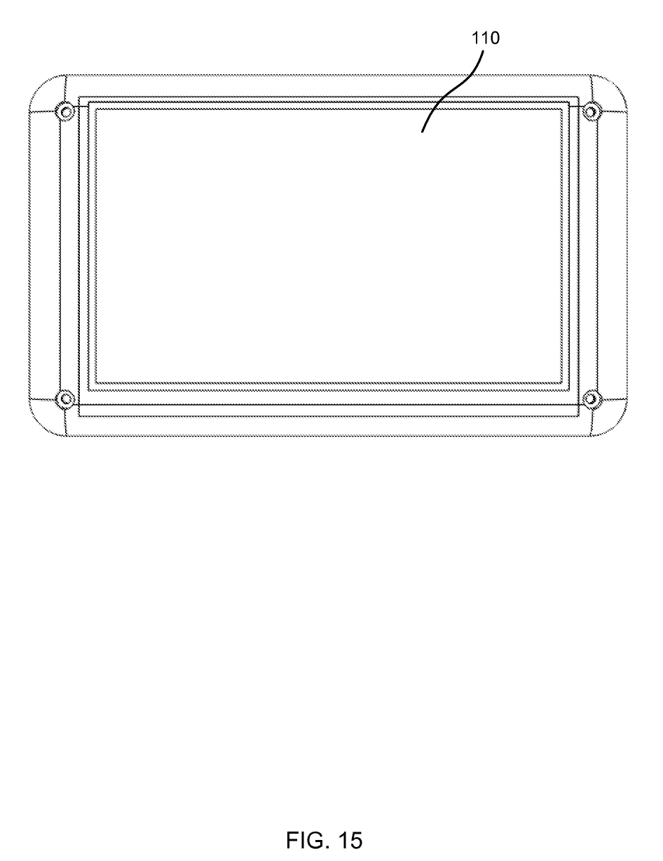

FIG. 15 is a schematic diagram of a display screen of an example media display device with the lid removed for clarity purposes. As described above the display screen 110 may be any of Thin Film Transistor (TFT), Liquid Crystal Display screen (LCD), Light Emitting Diode (LED), Organic Light Emitting Diode (O-LED) or any other appropriate display device. In an embodiment the display screen may additionally be a user input device. A non-limiting list of examples of appropriate touch screen display screens is; resistive display screens, capacitive display screens, infra-red touch-screen, acoustic pulse touch-screen, coded LED touch-screen.

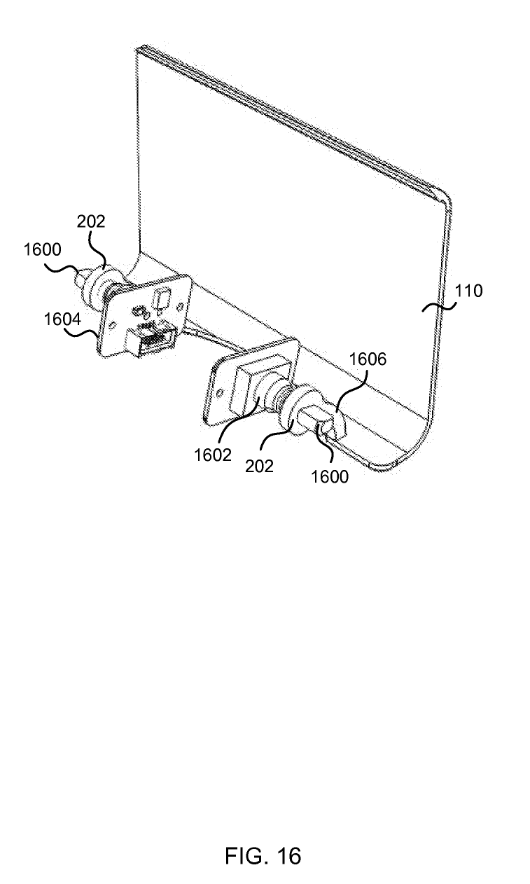

FIG. 16 is a perspective view of an example hinge configuration connected to a lid 110. For clarity the body of the media display device is not shown. In this example two hinges 202 are provided although any suitable number of hinges may be used.

In this example each hinge comprises a essentially disk through which an axle 1600 of a rotary encoder is inserted. Extending from the disk is a curved arm 1606 which is fixed to the lid 110. The axle 1600 of the rotary encoder may rotate about its longitudinal axis. The rotary encoder converts the angular position of the axle 1600 into a digital or analog signal. The output from one or both of the rotary encoders (at the two hinges) may be used as the open/close sensor (318 of FIG. 3).

The rotary encoder may be an incremental rotary encoder. In an example the rotary encoder has two outputs 1602, 1604 which may be quadrature outputs. In an example a mechanical rotary encoder can be used. In another example optical rotary encoders can be used. The two outputs A 1602 and B 1604 may be quadrature outputs which are 90 degrees out of phase. One of the outputs is a reference output although the reference output may be either output.

In an example where the rotary encoder is a mechanical rotary encoder there are two contacts that are actuated by cams on the rotating shaft 1600. There can be an optional third output: reference, which happens once every turn. Incremental encoders are used to track motion and can be used to determine position and velocity by providing an A 1602 and a B 1604 pulse output. The counting is done in the external electronics. The incremental encoder reports an incremental change in position of the encoder to the counting electronics. Because the direction can be determined, very accurate measurements can be made and the rotary encoder can be used to determine whether the media display device is open or closed.

In another example one or both of the incremental encoders are replaced with absolute-position encoders (such as rotary potentiometers), which give a measurement of the position of the encoder at any point (as an analog voltage output) in addition to rate and direction.

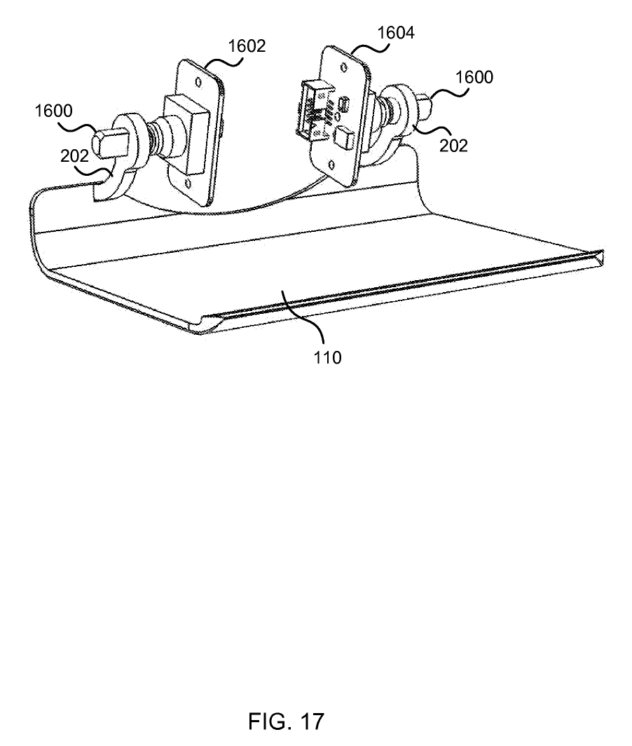

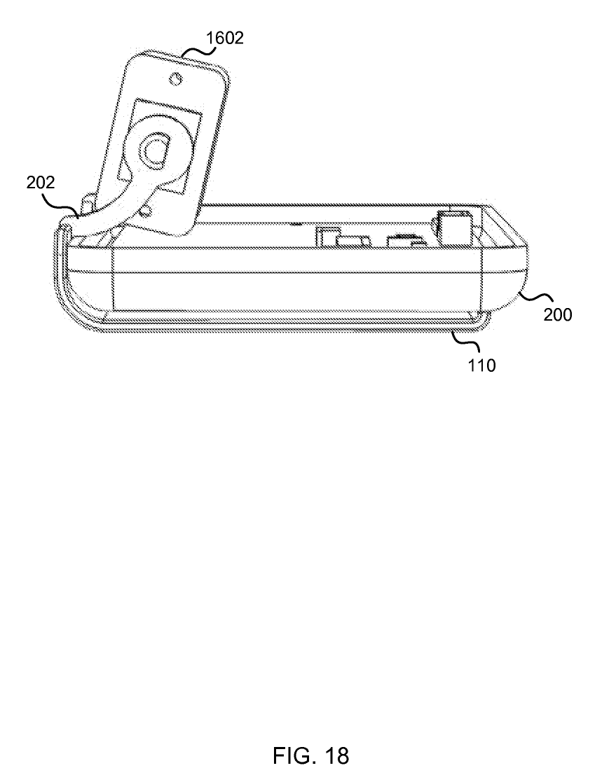

FIG. 17 is another perspective view of the hinge configuration of FIG. 16. Once again the body of the media display device is removed for clarity. FIG. 18 is another perspective view of the hinge configuration. In FIG. 18 the display screen 200 has been included to demonstrate its location relative to the hinge 202 arrangement and the rotary encoder 1602 when the media display device is in a closed position.

Although a rotary encoder hinge arrangement is described with reference to the examples herein as a mechanism for determining if the media display device is open or closed this is described by way of example only and is not intended to be the only possible configuration. In other embodiments a hinge, for example a barrel hinge may be used to open and close the media display device and another kind of sensor may be used to determine if the device is open or closed, for example an accelerometer, light sensor or other appropriate sensor.

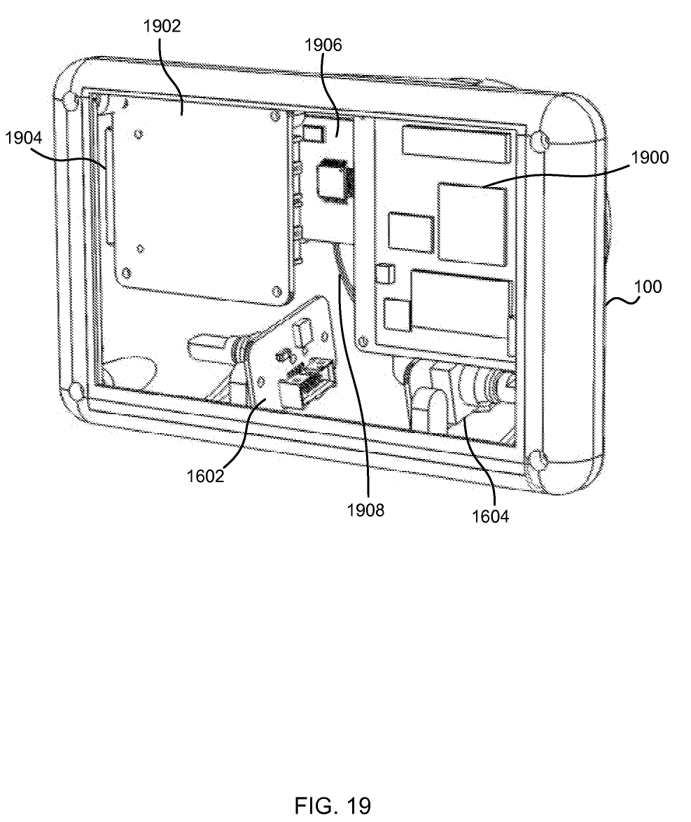

FIG. 19 is a perspective view of an example media display device with the display screen and loudspeaker removed for clarity. The device comprises a main board 1900, a memory card reader 1902 into which a memory card 1904 may be inserted and an audio module 1906 which may be, for example a digital to analogue converter (DAC). Rotary encoders 1602, 1604 as described above are additionally visible. The hole 1908 in the housing into which the loudspeaker is inserted is partially visible. The main board may comprise at least a processor and memory but may have additional components. The memory card reader 1902 can be used to read and write media items from a memory card 1904. An example of an appropriate type of memory card 1904 is an SD Card. In an example memory card reader 1902 is an SD card reader. In another example memory card reader 1902 is a multi-card reader.

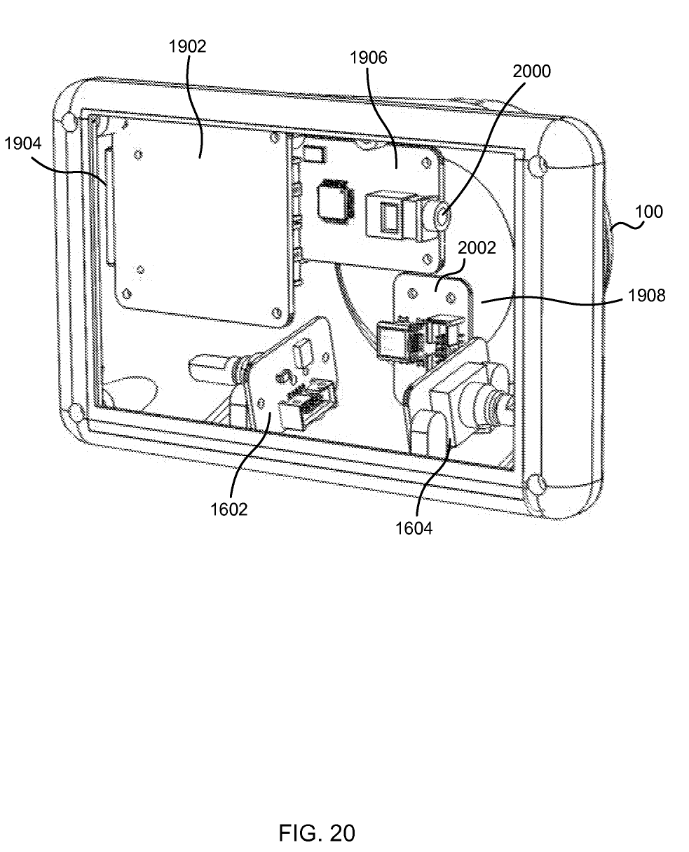

FIG. 20 is a schematic diagram of an example of the media display device with the display screen, loudspeaker and main board removed for clarity. The audio module 1906 is shown. The audio signal can be output to the loudspeaker or other output device using a connector 2000, for example a TRS connector or an RCA connector.

The power supply unit 2002 is shown in FIG. 20. The power supply unit may, for example be a USB or micro USB power supply. In other examples it may be a rechargeable battery or other appropriate power supply.

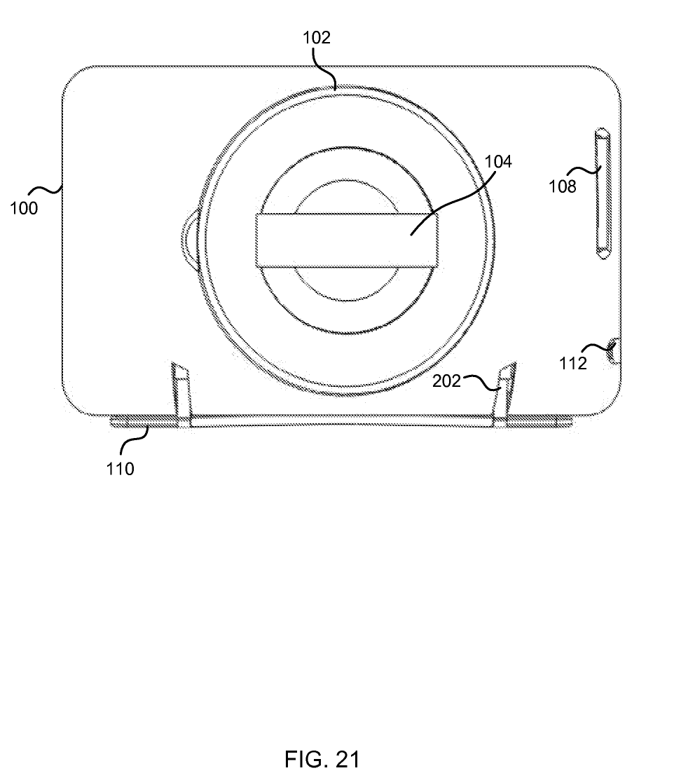

FIG. 21 is a plan view of the media display device when closed. The loudspeaker 102 is shown.

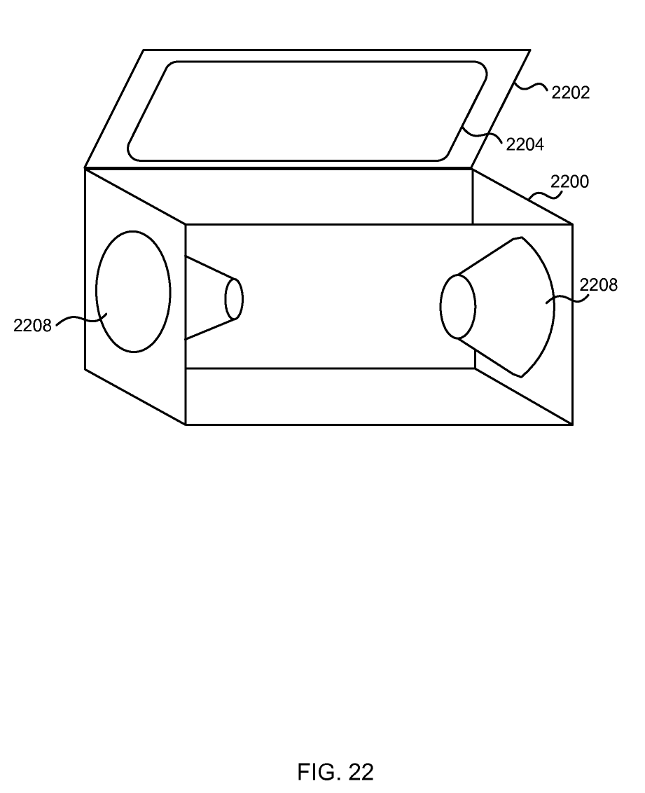

FIG. 22 is a schematic diagram of another example configuration of a media display device. In this embodiment the media display device has the form of a music or trinket box designed to provoke the curiosity of the user to open the box 2200. The lid of the box 2202 comprises an internal display screen 2204 such that when the box is opened the display screen is visible. In another example, the display screen 2204 is mounted inside the box on the base. In this case the user moves closer to the box in order to look inside it and view the display screen and this further provokes the user's curiosity. The box may additionally incorporate one or more loudspeakers 2208. In this embodiment music or other audio files may be played through the loudspeaker when the box is closed. In an example an audio prompt may be played encouraging the user to open the box. In an example when the user opens the box an image or other media file, e.g. a video clip is displayed on the display screen. Content may additionally be played through the one or more loudspeakers 2208 when the box is open. The display screen 2204 may be any appropriate type of display screen. Content may be received and presented at the media display device using the methods described herein. In an example the lid 2202 may additionally comprise an auto-open/auto-close feature.

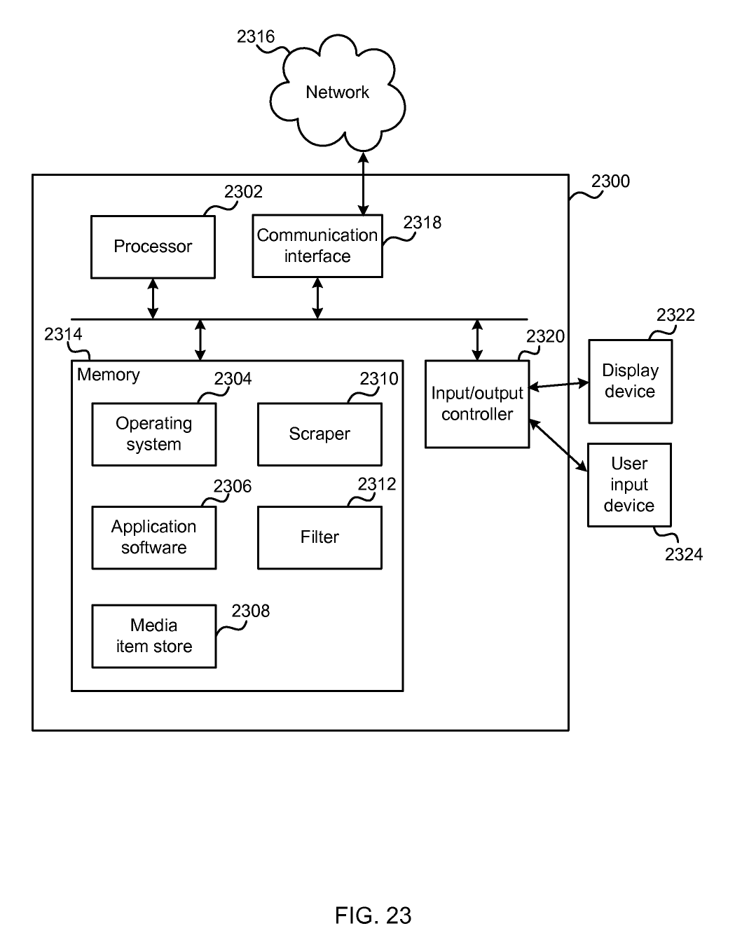

FIG. 23 illustrates various components of an exemplary computing-based device 2300 which may be implemented as any form of a computing and/or electronic device, and in which embodiments of a media display device may be implemented.

Computing-based device 2300 comprises one or more processors 2302 which may be microprocessors, controllers or any other suitable type of processors for processing computing executable instructions to control the operation of the device in order to scrape and/or display selected media items. Platform software comprising an operating system 2304 or any other suitable platform software may be provided at the computing-based device to enable application software 2306 to be executed on the device.

Additional software may comprise a scraper 2310 to scrape media items, a filter 2312 which may be used in conjunction with the scraper 2310 in order to download media content items for display and a media item store 2308.

The computer executable instructions may be provided using any computer-readable media that is accessible by computing based device 2300. Computer-readable media may include, for example, computer storage media such as memory 2314 and communications media. Computer storage media, such as memory 2314, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store information for access by a computing device. In contrast, communication media may embody computer readable instructions, data structures, program modules, or other data in a modulated data signal, such as a carrier wave, or other transport mechanism. Although the computer storage media (memory 2314) is shown within the computing-based device 2300 it will be appreciated that the storage may be distributed or located remotely and accessed via a network 2316, for example the internet, a mobile telecommunications network or other communication link (e.g. using communication interface 2318).

The computing-based device 2300 also comprises an input/output controller 2320 arranged to output information to a display device 2322 which may be separate from or integral to the computing-based device 2300. The display information may provide a graphical user interface. The input/output controller 2320 is also arranged to receive and process input from one or more devices, such as a user input device 2324 (e.g. a mouse or a keyboard). This user input may be used to receive feedback from users about the type of media items displayed. In an embodiment the display device 2322 may also act as the user input device 2324 if it is a touch sensitive display device. The input/output controller 2320 may also output data to devices other than the display device, e.g. an audio output, for example a loudspeaker or a locally connected printing device (not shown in FIG. 23).

The term ‘computer’ is used herein to refer to any device with processing capability such that it can execute instructions. Those skilled in the art will realize that such processing capabilities are incorporated into many different devices and therefore the term ‘computer’ includes PCs, servers, mobile telephones, personal digital assistants and many other devices.

The methods described herein may be performed by software in machine readable form on a tangible storage medium. Examples of tangible (or non-transitory) storage media include disks, thumb drives, memory etc and do not include propagated signals. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description of a preferred embodiment is given by way of example only and that various modifications may be made by those skilled in the art. The above specification, examples and data provide a complete description of the structure and use of exemplary embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention.

1. A media display device comprising:
a display screen;
at least one loudspeaker;
a housing arranged to hold the display screen and the loudspeaker;
the housing being rotatably mounted on a lid such that the housing is movable between a closed position in which the display screen is covered by the lid and an open position in which the display screen is uncovered;
a sensor arranged to detect when the lid opens or closes;
a memory arranged to store a plurality of items of media content;
a processor arranged, when the lid opens or closes, to select an item of media content from the memory in a manner having at least a partial random element and to display it at the device using any of the loudspeaker and the display screen.

2. A media display device as claimed in claim 1 wherein the items of media content stored at the memory are pre-selected as items not having been used in a specified time period.

3. A media display device as claimed in claim 1 wherein the memory is arranged to store items of media content of a plurality of different types and wherein the processor is arranged to randomly select the type of media content item to be displayed.

4. A media display device as claimed in claim 1 wherein the housing is sized and shaped to fit into a hand of a user and to act as a handle for opening the device during use.

5. A media display device as claimed in claim 4 wherein the housing is sized and shaped to hold the loudspeaker such that it fits into the palm of the user's hand during opening of the device and the display screen such that it is held between fingers and thumb of one hand of a user during opening of the device.

6. A media display device as claimed in claim 1 wherein the lid is sized and shaped to act as a stand such that when the device is in the open position the housing is supported by the stand.

7. A media display device as claimed in claim 1 wherein the lid comprises anti-slip features to reduce slipping of the lid against a supporting surface during use when the device is being opened by a user, the anti-slip features being selected from any one or more of: suction cups, anti-slip pads, textured regions, weights.

8. A media display device as claimed in claim 1 wherein the sensor comprises at least one rotary encoder.

9. A media display device as claimed in claim 8 wherein the housing is mounted on the lid by using an axle of the rotary encoder as part of a hinge.

10. A media display device as claimed in claim 8 wherein the rotary encoder is attached to the housing and the lid is connected to the axle of the rotary encoder using an arm extending from the lid, the arm having a disc through which the axle of the rotary encoder passes.

11. A media display device as claimed in claim 1 wherein the display screen is a touch screen arranged to receive user input and wherein the processor is arranged to control selection of the media content items from the memory on the basis of that user input.

12. A media display device as claimed in claim 1 comprising wireless communications unit arranged to receive media content items for storage at the memory.

13. A media display device as claimed in claim 1 wherein the processor is arranged to scrape media content items from at least one specified location on the basis of specified criteria and information about available capacity at the memory.

14. A media display device as claimed in claim 1 which comprises a mechanism for self-closing of the device.

15. A media display device comprising:
a display screen;
at least one loudspeaker;
a housing arranged to hold the display screen and the loudspeaker;
the housing being rotatably mounted on a lid such that the housing is movable between a closed position in which the display screen is covered by the lid and an open position in which the display screen is uncovered;
a sensor arranged to detect when the lid opens or closes;
a memory arranged to store a plurality of items of media content of different media types which have been pre-selected as items of media content not having been used for more than a specified time;
a processor arranged, when the lid opens or closes, to select an item of media content from the memory in a manner having at least a partial random element and to display it at the device using any of the loudspeaker and the display screen.

16. A media display device as claimed in claim 15 wherein the sensor comprises at least one rotary encoder.

17. A media display device as claimed in claim 16 wherein the housing is mounted on the lid by using an axle of the rotary encoder as part of a hinge.

18. A media display device comprising:
a display screen;
at least one loudspeaker;
a housing arranged to hold the display screen and the loudspeaker;
the housing being rotatably mounted on a lid such that the housing is movable between a closed position in which the display screen is covered by the lid and an open position in which the display screen is uncovered;
a sensor arranged to detect when the lid opens or closes;
a memory arranged to store a plurality of items of media content;
a processor arranged, when the lid opens or closes, to select an item of media content from the memory in a manner having at least a partial random element and to display it at the device using any of the loudspeaker and the display screen;
wherein the housing is sized and shaped to fit into a hand of a user and to act as a handle for opening the device during use.

19. A media display device as claimed in claim 18 wherein the housing is sized and shaped to hold the loudspeaker such that it fits into the palm of the user's hand during opening of the device and to support the display screen such that it is held between fingers and thumb of one hand of a user during opening of the device

20. A media display device as claimed in claim 18 wherein the lid comprises anti-slip features to reduce slipping of the lid against a supporting surface during use when the device is being opened by a user, the anti-slip features being selected from any one or more of: suction cups, anti-slip pads, textured regions, weights.
